(19) United States
(12) Patent Application Publication
(10) Pub. No.: US 2025/0232186 A1
(43) Pub. Date: Jul. 17, 2025

(54) FEDERATED UNLEARNING METHOD BASED ON MALICIOUS TERMINAL INTERVENTION TRAINING

(71) Applicant: DALIAN UNIVERSITY, Dalian, Liaoning (CN)

(72) Inventors: Dongsheng ZHOU, Dalian, Liaoning (CN); Xintong GUO, Dalian, Liaoning (CN); Pengfei WANG, Dalian, Liaoning (CN); Qiang ZHANG, Dalian, Liaoning (CN); Xiaopeng WEI, Dalian, Liaoning (CN); Ruiyun YU, Dalian, Liaoning (CN)

(21) Appl. No.: 18/697,677

(22) PCT Filed: Aug. 18, 2023
(86) PCT No.: PCT/CN2023/113649

§ 371 Date: Apr. 1, 2024

(30) Foreign Application Priority Data
Apr. 10, 2023 (CN) 202310371399.3

(51) Int. Cl. G06N 3/098

(52) U.S. Cl. CPC G06N 3/098

(57) ABSTRACT

A federated unlearning method based on malicious terminal intervention training and belongs to the technical field of privacy computing and federated learning, which eliminates the influence of the malicious client on the global model through federated unlearning and subtracts the parameter updates of the malicious client from the parameters of the final global model generated by federated learning to save the retraining time by continuing training with a theoretically unusable low-quality model. A comparison mechanism for judging the effect of the previous round of unlearning model and the effect of the current round of unlearning model to analyze the unlearning effects is also provided. The final unlearning model is trained with a small dataset and the deviations produced by the training process on the model are recovered, which effectively improves the accuracy of the final unlearning model.

### TECHNICAL FIELD

The present invention relates to the technical field of privacy computing and federated learning (FL), in particular to a federated unlearning method based on malicious terminal intervention training.

### BACKGROUND

With the advent of the era of big data, people are paying more and more attention to the privacy protection of personal data. The relevant laws also implement the protection of the security of user data. The General Data Protection Regulation (GDPR) restricts the permission of enterprises to use user data and enhances the rights of data owners. It gives the owners the right to erasure, allowing them to ask involved training models to erase the contributions made by the owners. The federated unlearning method is a derivative method of FL, which can erase the contributions made by owners exercising the right to erasure in FL. This method not only enables the data owners to train models locally and enjoy absolute control over the data, but also enables the owners to exercise the right to erasure smoothly.

Federated unlearning is a new method based on FL, which has strong extensibility. In FL training, each data owner selected by the server as a client trains models locally. They then send model parameters to the server for aggregation and iteration to generate a final global model. The traditional federated unlearning method is to retrain. This means excluding the clients exercising the right to erasure and selecting the remaining clients to perform FL again.

Despite huge potential in the field of privacy computing, federated unlearning is still in the starting stage and has fewer related methods. Moreover, due to the excessive idealization of client status, the limitation of unlearning nodes and the failure of rational use of the aggregated global model in FL, the prerequisite of existing federated unlearning methods is that the client has excellent data and voluntarily performs the unlearning operation. Some federated unlearning methods can only perform the unlearning operation during the training round in which the client requests to erase the contributions, which will delay subsequent FL. In addition, when the client maliciously provides inferior data for FL, the existing federated unlearning methods cannot effectively eliminate malicious influence.

### SUMMARY

In view of the above problems in the prior art, the present invention proposes a federated unlearning method based on malicious terminal intervention training, which effectively uses the global model generated by FL, reduces the influence of the malicious client involved in FL, and uses the server to perform the unlearning operation without considering the cooperation degree of the client, thereby improving the predicting accuracy of the model and indirectly improving excessive unlearning of the model.

To achieve the above purpose, the present invention adopts the following technical solution:

A federated unlearning method based on malicious terminal intervention training, comprising the following steps:
Step 1: building an FL framework, constructing a convolutional neural network model, and setting clients C={C₁, C₂, . . . , C_{N}} involved in training and local training data D={D₁, D₂, . . . , D_{N}} of the clients, wherein C_{N} is a malicious client;
Step 2: improving the setting of experimental parameters, storing a benchmark dataset D_{b} in a central server, then performing FL training, recording each round of training parameter update ΔM of the malicious client in the central server, finally obtaining a final global model M_{T} and conducting tests to obtain a predicting score acc(M_{T});
Step 3: loading the final global model M_{T} obtained in step 2 and the parameter updates of the malicious client, performing unlearning operation, establishing an unlearning model M_{T}′, setting the parameters as the parameters of the final global model minus each round of parameter update of the malicious client, and deciding whether to terminate the unlearning operation in advance by judging the predicting score of the unlearning model;
Step 4: loading the unlearning model M_{T}′ obtained in step 3, performing normal training on the unlearning model using the benchmark dataset for a specified number of times to recover model performance deviations produced when performing the unlearning operation, and finally outputting the unlearning model at this moment as a final model;
Step 5: loading the model obtained in step 4, inputting data test set images for testing the model into the trained final unlearning model, and after obtaining the corresponding predicting score, determining the performance of the model.

Further, the step 1 specifically comprises:
Step 1.1: for an MNIST dataset, performing FL using a customized network CNNMNIST, and defining two convolutional layers and two fully connected layers, wherein the first convolutional layer Conv₁ has an input dimension of 3, an output dimension of 20, a convolution kernel size of 5 and a step size of 1; the second convolutional layer Conv₂ has an input dimension of 20, an output dimension of 50, a convolution kernel size of 3 and a step size of 1; the first fully connected layer Fc₁ maps 1250 dimensions to 500 dimensions; and the second fully connected layer Fc₂ maps 500 dimensions to 10 dimensions.

The specific structure of a CNNMNIST model is as follows:

Firstly, executing the convolutional layers. After each convolutional layer is run, continuing to execute an activation function and a maximum pooling layer. Executing the first convolutional layer Conv₁ and then the second convolutional layer Conv₂. The process is expressed by formula (1):

$$X = Maxpool ( Rel u ( C o n {v}_{i} ( X ) ) ) \qquad ( 1 )$$

wherein X is input training data; Maxpool is the maximum pooling layer; Relu is the activation function; Convᵢ is the i^{th} convolutional layer; and i=1, 2, indicating the index of the convolutional layer.

After the end of the above process, using a view function in Python to automatically adjust the input training data X to have 1250 elements in each dimension, which is expressed by formula (2):

$$X = X . view ( - 1.125 ) \qquad ( 2 )$$

Then, executing the first fully connected layer Fc₁ and the second fully connected layer Fc₂ respectively, which is expressed by formula (3):

$$X = {Fc}_{j} ( X ) \qquad ( 3 )$$

wherein Fcⱼ is the j^{th} fully connected layer; and j=1, 2, indicating the index of the fully connected layer.

Finally, using a log_softmax function to convert the input training data X to a probability value, which is expressed by formula (4):

$$X = log\_softmax ( X , dim = 1 ) \qquad ( 4 )$$

wherein the function of dim=1 is to convert X into a column.

For an FMNIST dataset, performing FL using the customized network CNNFMNIST. CNNFMNIST is similar to CNNMNIST in the structure except for only having the first fully connected layer, and the first fully connected layer FMNIST_Fc₁ maps 1250 dimensions to 10 dimensions.
Step 1.2: defining the malicious client Cy as a data owner with a large number of errors contained in local data labels.

Further, the step 2 specifically comprises:
Step 2.1: defining a dataset which contains correct data and is close to the local training data D_{N} of the client in data size as a benchmark dataset D_{b}. Therefore, storing the benchmark dataset D_{b} in the central server in advance to facilitate subsequent repair of the performance deviations of the unlearning model. Moreover, since the size of the benchmark dataset is 1/N of the local training data D, only a small amount of storage space is required to complete the performance recovery of the unlearning model.
Step 2.2: FL is a process in which each client involved in training downloads the current training round of global model from the central server; after using local data to train the current training round of global model downloaded from the central server, generating a local model; and then uploading updated parameters of the local model to the central server, aggregating to generate a new round of global model, and iterating until the converge of the global model. The FL training process can be expressed by formula (5):

$${M}_{t} = {M}_{t - 1} + \frac{1}{N} {\sum }_{C = 1}^{N} Δ {M}_{C}^{t} \qquad ( 5 )$$

wherein Mₜ is a global model generated by the t(t≥1)^{th} round of FL; N is the total number of clients involved in training; and ΔM_{C}^{t} represents parameter update generated by the local model of the client C in the t^{th} round.
Step 2.3: using a test set Dₜ for prediction of results to obtain a predicting score acc(M_{T}) of the model, wherein the test process can be expressed by formula (6):

$$a c c ( {M}_{T} ) = test ( {D}_{t} , {M}_{T} ) \qquad ( 6 )$$

wherein test is a test function, and Dₜ and M_{T} are input variables.

Further, the step 3 specifically comprises:

The present invention designs a federated unlearning method for subtracting parameter updates through theoretical derivation, and the above process is as follows:
Step 3.1: the parameters of the global model after each round of aggregation and the parameters of the previous round of global model differ by parameters obtained by weighted aggregation of the local model of each client in the current round, and the parameter update ΔM^{t} of the t^{th} round of global model can be expressed by formula (7):

$$Δ {M}^{t} = \frac{1}{N} {\sum }_{C = 1}^{N} Δ {M}_{C}^{t} \qquad ( 7 )$$

Step 3.2: since the malicious client is also involved in the training, the parameter updates of local models of excellent clients and the malicious client can be calculated separately, so the parameter update ΔM^{t} of the t^{th} round of global model is expressed by formula (8):

$$Δ {M}^{t} = \frac{1}{N} {\sum }_{C = 1}^{N - 1} Δ {M}_{C}^{t} + \frac{1}{N} Δ {M}_{C}^{t} \qquad ( 8 )$$

wherein ΔM_{N}^{t} is parameter update generated by the local model of the malicious client C_{N} in the t^{th} round.
Step 3.3: from the perspective of retrained federated unlearning, the t^{th} round of parameter update ΔM^{t′} of the unlearning model is parameter aggregation of local models of N−1 excellent clients, which can be decomposed into formula (9) through formula simplification:

$$Δ {M}^{{t}^{′}} = \frac{1}{N - 1} {\sum }_{C = 1}^{N - 1} Δ {M}_{C}^{t} = \frac{N}{N - 1} Δ {M}^{t} - \frac{1}{N - 1} Δ {M}_{C}^{t} \qquad ( 9 )$$

Then, when the parameter update of the malicious client approaches 0, the t^{th} round of parameter update of the unlearning model will bring great changes due to a coefficient

$$\frac{N}{N - 1} ,$$

and produce a certain deviation. To avoid this scenario, assuming that the t^{th} round of parameter update of the malicious client is 0, that is, no contribution is made, the simplification result can be expressed by formula (10):

$$Δ {M}^{{t}^{′}} = \frac{1}{N} {\sum }_{C = 1}^{N - 1} Δ {M}_{C}^{t} = Δ {M}^{t} - \frac{1}{N} Δ {M}_{N}^{t} \qquad ( 10 )$$

Step 3.4: combining formula (10) and formula (4), thus obtaining that the final global model of FL minus each round of parameter update of the malicious client is the final unlearning model M_{T}′, which can be expressed by formula (11):

$${M}_{T}^{′} = {M}_{0} + {\sum }_{t = 1}^{T} Δ {M}^{t} - \frac{1}{N} {\sum }_{t = 1}^{T} Δ {M}_{N}^{t} = {M}_{T} - \frac{1}{N} {\sum }_{t = 1}^{T} Δ {M}_{N}^{t} \qquad ( 11 )$$

wherein T is the number of times of the final round of training of federated unlearning.
Step 3.5: on the whole, subtracting the parameter updates of the malicious client can achieve contributions of the malicious client unlearned by the global model, but may cause excessive unlearning, which will lead to performance degradation of the model. In this process, the effect of the unlearning model is judged to determine whether to terminate the unlearning operation in advance; and during the 1^{st} round of unlearning operation, the previous round of unlearning model Mₚᵣₑ′ is the final global model M_{T}, and the current round of unlearning model M_{cur}′ is the previous round of unlearning model minus the 1st round of parameter update of the malicious client, as shown in formula (12), until the accuracy of the previous round of unlearning model is greater than that of the current round of unlearning model, indicating that an over-unlearning phenomenon occurs, the unlearning operation can be terminated in advance, and the final unlearning model is the previous round of unlearning model.

$${M}_{c u r}^{′} = {M}_{p r e}^{′} - \frac{1}{N} {M}_{N}^{t} {M}_{p r e}^{′} = \{ \begin{matrix}{M}_{T} & ( t = 1 ) \\ {M}_{c u r}^{′} & ( t > 1 )\end{matrix} \} if acc ( {M}_{p r e}^{′} ) > acc ( {M}_{c u r}^{′} ) : {M}_{T}^{′} = {M}_{p r e}^{′} \qquad ( 12 )$$

Further, the step 4 specifically comprises:

The final unlearning model M_{T}′ obtained in step 3.5 also needs performance repair due to model performance deviations produced when performing the federated unlearning. The final unlearning model M_{T}′ is trained with the benchmark dataset D_{b} for additional m times, which can enhance the final model prediction effect.

Further, the step 5 specifically comprises:

Loading the final unlearning model trained in step 4, inputting data test set images for testing the model into the trained final unlearning model, and after obtaining the corresponding predicting score by calculating whether the predicting labels of the test data are consistent with the actual labels, determining the performance of the model.

The present invention has the following beneficial effects: the present invention eliminates the influence of the malicious client on the global model through federated unlearning, and subtracts the parameter updates of the malicious client from the parameters of the final global model generated by FL to save the retraining time by continuing training with a theoretically unusable low-quality model so that the server can eliminate the influence of the malicious client more quickly when performing the unlearning operation, without soliciting the wishes of the client whose contributions are erased; the present invention proposes a comparison mechanism for judging the effect of the previous round of unlearning model and the effect of the current round of unlearning model to analyze the unlearning effects, so as to terminate the unlearning operation in advance to restrain the influence of the unlearning model due to excessive unlearning; and the final unlearning model is trained with a small dataset, and the deviations produced by the training process on the model are recovered, which effectively improves the accuracy of the final unlearning model.

### DESCRIPTION OF DRAWINGS

FIG. 1 is an overall structural schematic diagram of a federated unlearning method based on malicious terminal intervention training of the present invention;

FIG. 2 is a flow diagram of a federated unlearning method based on malicious terminal intervention training of the present invention;

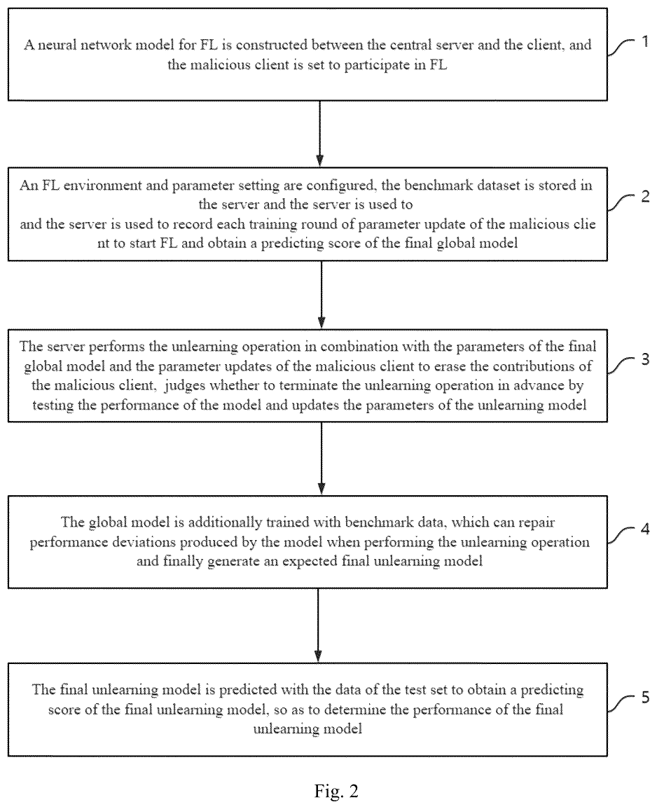

FIG. 3 is a flow diagram of step 2 in a federated unlearning method of the present invention.

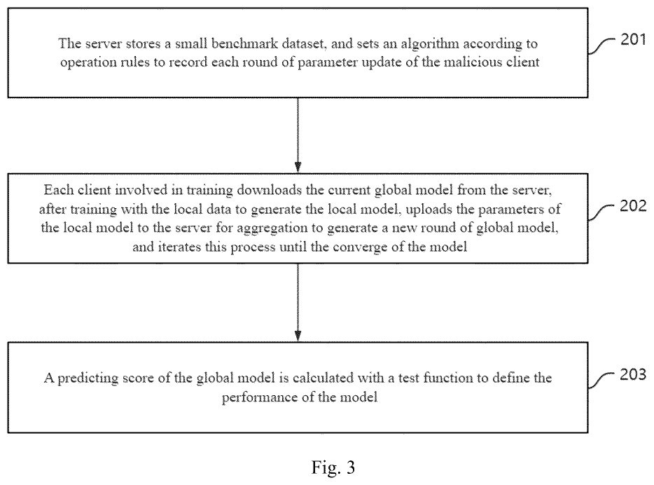

### DETAILED DESCRIPTION

The embodiments of the present invention are implemented on the premise of the technical solution of the present invention, and detailed implementation mode and specific operation procedures are given, but the protection scope of the present invention is not limited to the following embodiments.

The present embodiment takes a Windows system as the development environment, PyCharm as the development platform, Python as the development language and PyTorch as the development framework, and adopts the federated unlearning method based on malicious terminal intervention training of the present invention to complete the label prediction for the image dataset.

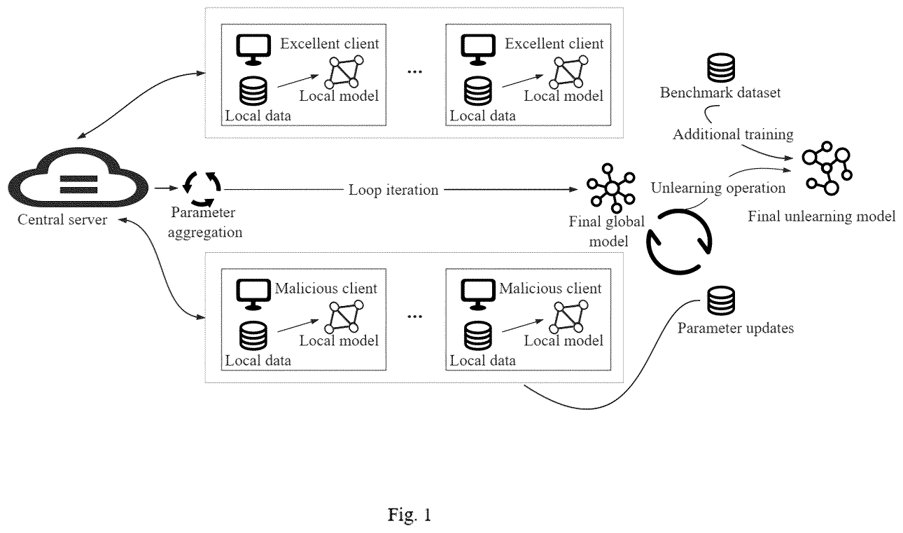

The present invention uses the MNIST dataset and the FMNIST dataset as input data to carry out experiments respectively. In the present embodiment, for example, with the MNIST dataset as input data, the federated unlearning method based on malicious terminal intervention training comprises the following steps:
Step 1: loading the customized convolutional neural model and the corresponding benchmark dataset and test dataset into the central server as shown in FIG. 1;
Step 2: setting a client involved in training, as shown in FIG. 1, assigning local data to the client, and appropriately adding error data, so that the server learns the historical parameter updates of the malicious client and is prepared for training based on the environment configuration in step 1;
Step 3: the server issues an FL command, each client loads the customized convolutional neural model set in step 1 as an initial model, the local model is obtained by training the initial model with the local data and then uploaded to the server, and a new round of global model is obtained through aggregation by the server. Then, the server subtracts each round of parameter update of the malicious client from the parameters of the final global model and judges the unlearning effect. If the unlearning effect reaches perfection, stopping unlearning, and starting to recover the model performance deviations through additional training. The present invention uses accuracy, that is a ratio of the accurate number of times of image label prediction to the total number of predicted images when the test set images are taken as input, as the model performance evaluation index. The computing mode can be expressed by formula (13), wherein Acc is the predicting score of the model, and S_{c} and Sₜₒₜₐₗ represent the number of times of correct model prediction and the total number of predictions respectively.

$$A c c = \frac{{S}_{c}}{{S}_{t o t a l}} \times 100 \% \qquad ( 13 )$$

According to the above steps, the present invention is compared with a method of FL retraining, an FL method containing a malicious client, a method of directly subtracting historical parameter updates of a malicious client, and a method of federated unlearning using knowledge distillation. It can be seen from Table 1 that the accuracy of the method proposed by the present invention is basically superior to that of other methods on MNIST dataset.

TABLE 1
Performance Comparison of Methods in MNIST Dataset

| Reference | Model | |
|---|---|---|
| Methods | Accuracy | Time |
| Retrain | 98.82 | 91 min |
| Mali-FL | 71.69 | 82 min |
| Sub-FL | 68.51 | 10 min |
| KD-UL | 78.84 | 17 min |
| FAST (The | 98.84 | 5 min |
| present | | |
| invention) | | |

The above only describes the specific embodiments of the present invention and is intended to describe the basic principle, advantages and purposes of the present invention. Those skilled in the art shall clearly understand that the present invention is not limited by the above embodiment and can contemplate further changes and replacements according to the above description and without departing from the spirit and scope of the present invention. The protection scope of the present invention is defined by the appended claims and equivalents.

1. A federated unlearning method based on malicious terminal intervention training, comprising the following steps:
step 1: building an FL framework, constructing a convolutional neural network model, and setting clients C={C₁, C₂, . . . , C_{N}} involved in training and local training data D={D₁, D₂, . . . , D_{N}} of the clients, wherein C_{N} is a malicious client;
step 2: improving the setting of experimental parameters, storing a benchmark dataset D_{b} in a central server, then performing FL training, recording each round of training parameter update ΔM of the malicious client in the central server, finally obtaining a final global model M_{T} and conducting tests to obtain a predicting score acc(M_{T});
step 3: loading the final global model M_{T} obtained in step 2 and the parameter updates of the malicious client, performing unlearning operation, establishing an unlearning model M_{T}′, setting the parameters as the parameters of the final global model minus each round of parameter update of the malicious client, and deciding whether to terminate the unlearning operation in advance by judging the predicting score of the unlearning model;
step 4: loading the unlearning model M_{T}′ obtained in step 3, performing normal training on the unlearning model using the benchmark dataset for a specified number of times to recover model performance deviations produced when performing the unlearning operation, and finally outputting the unlearning model at this moment as a final model;
step 5: loading the model obtained in step 4, inputting data test set images for testing the model into the trained final unlearning model, and after obtaining the corresponding predicting score, determining the performance of the model.

2. The federated unlearning method based on malicious terminal intervention training according to claim 1, wherein the step 1 specifically comprises:
step 1.1: for an MNIST dataset, performing FL using a customized network CNNMNIST, and defining two convolutional layers and two fully connected layers, wherein the first convolutional layer Conv₁ has an input dimension of 3, an output dimension of 20, a convolution kernel size of 5 and a step size of 1; the second convolutional layer Conv₂ has an input dimension of 20, an output dimension of 50, a convolution kernel size of 3 and a step size of 1; the first fully connected layer Fc₁ maps 1250 dimensions to 500 dimensions; and the second fully connected layer Fc₂ maps 500 dimensions to 10 dimensions;
the specific structure of a CNNMNIST model is as follows:
firstly, executing the convolutional layers; after each convolutional layer is run, continuing to execute an activation function and a maximum pooling layer; and executing the first convolutional layer Cony and then the second convolutional layer Conv₂, with the process expressed by formula (1):
$$X = Maxpool ( Rel u ( {Conv}_{i} ( X ) ) ) \qquad ( 1 )$$
wherein X is input training data; Maxpool is the maximum pooling layer; Relu is the activation function; Convᵢ is the i^{th} convolutional layer; and i=1, 2, indicating the index of the convolutional layer;
after the end of the above process, using a view function in Python to automatically adjust the input training data X to have 1250 elements in each dimension, which is expressed by formula (2):
$$X = X . view ( - 1 \text{.1250} ) \qquad ( 2 )$$
then, executing the first fully connected layer Fc₁ and the second fully connected layer Fc₂ respectively, which is expressed by formula (3):
$$X = {Fc}_{j} ( X ) \qquad ( 3 )$$
wherein Fcⱼ is the j^{th} fully connected layer; and j=1, 2, indicating the index of the fully connected layer;
finally, using a log_softmax function to convert the input training data X to a probability value, which is expressed by formula (4):
$$X = log\_softmax ( X , dim = 1 ) \qquad ( 4 )$$
wherein the function of dim=1 is to convert X into a column;
step 1.2: defining the malicious client C_{N} as a data owner with a large number of errors contained in local data labels.

3. The federated unlearning method based on malicious terminal intervention training according to claim 1, wherein the step 2 specifically comprises:
step 2.1: defining a dataset which contains correct data and is close to the local training data D_{N} of the client in data size as a benchmark dataset D_{b}; storing the benchmark dataset D_{b} in the central server in advance to facilitate subsequent repair of the performance deviations of the unlearning model; and since the size of the benchmark dataset is 1/N of the local training data D, only a small amount of storage space is required to complete the performance recovery of the unlearning model;
step 2.2: FL is a process in which each client involved in training downloads the current training round of global model from the central server; after using local data to train the current training round of global model downloaded from the central server, generating a local model; then uploading updated parameters of the local model to the central server, aggregating to generate a new round of global model, and iterating until the converge of the global model; and the FL training process is expressed by formula (5):
$${M}_{t} = {M}_{t - 1} + \frac{1}{N} {\sum }_{C = 1}^{N} Δ {M}_{C}^{t} \qquad ( 5 )$$
wherein Mₜ is a global model generated by the t^{th} round of FL, t≥1; N is the total number of clients involved in training; and ΔM_{C}^{t} represents parameter update generated by the local model of the client C in the t^{th} round;
step 2.3: using a test set Dₜ for prediction of results to obtain a predicting score acc(M_{T}) of the model, wherein the test process is expressed by formula (6):
$$acc ( {M}_{T} ) = test ( {D}_{t} , {M}_{T} ) \qquad ( 6 )$$
wherein test is a test function, and Dₜ and M_{T} are input variables.

4. The federated unlearning method based on malicious terminal intervention training according to claim 1, wherein the step 3 specifically comprises:
step 3.1: the parameters of the global model after each round of aggregation and the parameters of the previous round of global model differ by parameters obtained by weighted aggregation of the local model of each client in the current round, and the parameter update ΔM^{t} of the t^{th} round of global model is expressed by formula (7):
$$Δ {M}^{t} = \frac{1}{N} {\sum }_{C = 1}^{N} Δ {M}_{C}^{t} \qquad ( 7 )$$
step 3.2: since the malicious client is also involved in the training, the parameter updates of local models of excellent clients and the malicious client can be calculated separately, so the parameter update ΔM^{t} of the t^{th} round of global model is expressed by formula (8):
$$Δ {M}^{t} = \frac{1}{N} {\sum }_{C = 1}^{N - 1} Δ {M}_{C}^{t} + \frac{1}{N} Δ {M}_{N}^{t} \qquad ( 8 )$$
wherein ΔM_{N}^{t} is parameter update generated by the local model of the malicious client C_{N} in the t^{th} round;
step 3.3: from the perspective of retrained federated unlearning, the t^{th} round of parameter update ΔM^{t′} of the unlearning model is parameter aggregation of local models of N−1 excellent clients, which is decomposed into formula (9) through formula simplification:
$$Δ {M}^{{t}^{′}} = \frac{1}{N - 1} {\sum }_{C = 1}^{N - 1} Δ {M}_{C}^{t} = \frac{N}{N - 1} Δ {M}^{t} - \frac{1}{N - 1} Δ {M}_{N}^{t} \qquad ( 9 )$$
then, assuming that the t^{th} round of parameter update of the malicious client is 0, that is, no contribution is made, the simplification result is expressed by formula (10):
$$Δ {M}^{{t}^{′}} = \frac{1}{N} {\sum }_{C = 1}^{N - 1} Δ {M}_{C}^{t} = Δ {M}^{t} - \frac{1}{N} Δ {M}_{N}^{t} \qquad ( 10 )$$
step 3.4: combining formula (10) and formula (4), thus obtaining that the final global model of FL minus each round of parameter update of the malicious client is the final unlearning model M_{T}′, which is expressed by formula (11):
$${M}_{T}^{′} = {M}_{0} + {\sum }_{t = 1}^{T} Δ {M}^{t} - \frac{1}{N} {\sum }_{t = 1}^{T} Δ {M}_{N}^{t} = {M}_{T} - \frac{1}{N} {\sum }_{t = 1}^{T} Δ {M}_{N}^{t} \qquad ( 11 )$$
wherein T is the number of times of the final round of training of federated unlearning;
step 3.5: choosing to judge the effect of the unlearning model to determine whether to terminate the unlearning operation in advance; and during the 1^{st} round of unlearning operation, the previous round of unlearning model Mₚᵣₑ′ is the final global model M_{T}, and the current round of unlearning model M_{cur}′ is the previous round of unlearning model minus the 1^{st} round of parameter update of the malicious client, as shown in formula (12), until the accuracy of the previous round of unlearning model is greater than that of the current round of unlearning model, indicating that an over-unlearning phenomenon occurs, the unlearning operation can be terminated in advance, and the final unlearning model is the previous round of unlearning model;
$${M}_{cur}^{′} = {M}_{pre}^{′} - \frac{1}{N} {M}_{N}^{t} \qquad ( 12 )$$
$${M}_{pre}^{′} = \{ \begin{matrix}{M}_{T} & ( t = 1 ) \\ {M}_{cur}^{′} & ( t > 1 )\end{matrix} \}$$
$$if acc ( {M}_{pre}^{′} ) > acc ( {M}_{cur}^{′} ) :$$
$${M}_{T}^{′} = {M}_{pre}^{′} .$$

5. The federated unlearning method based on malicious terminal intervention training according to claim 3, wherein the step 3 specifically comprises:
step 3.1: the parameters of the global model after each round of aggregation and the parameters of the previous round of global model differ by parameters obtained by weighted aggregation of the local model of each client in the current round, and the parameter update ΔM^{t} of the t^{th} round of global model is expressed by formula (7):
$$Δ {M}^{t} = \frac{1}{N} {\sum }_{C = 1}^{N} Δ {M}_{C}^{t} \qquad ( 7 )$$
step 3.2: since the malicious client is also involved in the training, the parameter updates of local models of excellent clients and the malicious client can be calculated separately, so the parameter update ΔM^{t} of the t^{th} round of global model is expressed by formula (8):
$$Δ {M}^{t} = \frac{1}{N} {\sum }_{C = 1}^{N - 1} Δ {M}_{C}^{t} + \frac{1}{N} Δ {M}_{N}^{t} \qquad ( 8 )$$
wherein ΔM_{N}^{t} is parameter update generated by the local model of the malicious client C_{N} in the t^{th} round;
step 3.3: from the perspective of retrained federated unlearning, the t^{th} round of parameter update ΔM^{t′} of the unlearning model is parameter aggregation of local models of N−1 excellent clients, which is decomposed into formula (9) through formula simplification:
$$Δ {M}^{{t}^{′}} = \frac{1}{N - 1} {\sum }_{C = 1}^{N - 1} Δ {M}_{C}^{t} = \frac{N}{N - 1} Δ {M}^{t} - \frac{1}{N - 1} Δ {M}_{N}^{t} \qquad ( 9 )$$
then, assuming that the t^{th} round of parameter update of the malicious client is 0, that is, no contribution is made, the simplification result is expressed by formula (10):
$$Δ {M}^{{t}^{′}} = \frac{1}{N} {\sum }_{C = 1}^{N - 1} Δ {M}_{C}^{t} = Δ {M}^{t} - \frac{1}{N} Δ {M}_{N}^{t} \qquad ( 10 )$$
step 3.4: combining formula (10) and formula (4), thus obtaining that the final global model of FL minus each round of parameter update of the malicious client is the final unlearning model M_{T}′, which is expressed by formula (11):
$${M}_{T}^{′} = {M}_{0} + {\sum }_{t = 1}^{T} Δ {M}^{t} - \frac{1}{N} {\sum }_{t = 1}^{T} Δ {M}_{N}^{t} = {M}_{T} - \frac{1}{N} {\sum }_{t = 1}^{T} Δ {M}_{N}^{t} \qquad ( 11 )$$
wherein T is the number of times of the final round of training of federated unlearning;
step 3.5: choosing to judge the effect of the unlearning model to determine whether to terminate the unlearning operation in advance; and during the 1^{st} round of unlearning operation, the previous round of unlearning model Mₚᵣₑ′ is the final global model M_{T}, and the current round of unlearning model M_{cur}′ is the previous round of unlearning model minus the 1^{st} round of parameter update of the malicious client, as shown in formula (12), until the accuracy of the previous round of unlearning model is greater than that of the current round of unlearning model, indicating that an over-unlearning phenomenon occurs, the unlearning operation can be terminated in advance, and the final unlearning model is the previous round of unlearning model;
$${M}_{cur}^{′} = {M}_{pre}^{′} - \frac{1}{N} {M}_{N}^{t} \qquad ( 12 )$$
$${M}_{pre}^{′} = \{ \begin{matrix}{M}_{T} & ( t = 1 ) \\ {M}_{cur}^{′} & ( t > 1 )\end{matrix} \}$$
$$if acc ( {M}_{pre}^{′} ) > acc ( {M}_{cur}^{′} ) :$$
$${M}_{T}^{′} = {M}_{pre}^{′} .$$

6. The federated unlearning method based on malicious terminal intervention training according to claim 1, wherein the step 4 specifically comprises: for the final unlearning model M_{T}′ obtained in step 3, the final unlearning model M_{T}′ is trained with the benchmark dataset D_{b} for additional m times, which can enhance the final model prediction effect.

7. The federated unlearning method based on malicious terminal intervention training according to claim 3, wherein the step 4 specifically comprises: for the final unlearning model M_{T}′ obtained in step 3, the final unlearning model M_{T}′ is trained with the benchmark dataset D_{b} for additional m times, which can enhance the final model prediction effect.

8. The federated unlearning method based on malicious terminal intervention training according to claim 4, wherein the step 4 specifically comprises: for the final unlearning model M_{T}′ obtained in step 3, the final unlearning model M_{T}′ is trained with the benchmark dataset D_{b} for additional m times, which can enhance the final model prediction effect.

9. The federated unlearning method based on malicious terminal intervention training according to claim 1, wherein the step 5 specifically comprises: loading the final unlearning model trained in step 4, inputting data test set images for testing the model into the trained final unlearning model, and after obtaining the corresponding predicting score by calculating whether the predicting labels of the test data are consistent with the actual labels, determining the performance of the model.

10. The federated unlearning method based on malicious terminal intervention training according to claim 2, wherein in the step 1.1, for an FMNIST dataset, performing FL using the customized network CNNFMNIST; and the CNNFMNIST is similar to CNNMNIST in the structure except for only having the first fully connected layer, and the first fully connected layer FMNIST_Fc₁ maps 1250 dimensions to 10 dimensions.
